(19) United States
(12) Patent Application Publication
(10) Pub. No.: US 2018/0224107 A1
(43) Pub. Date: Aug. 9, 2018

(54) Lighting system

(71) Applicant: Henry C. Harbers, JR., San Luis Obispo, CA (US)

(72) Inventor: Henry C. Harbers, JR., San Luis Obispo, CA (US)

(21) Appl. No.: 15/530,597

(22) Filed: Feb. 6, 2017

(51) Int. Cl. F21V 23/02; F21V 23/00; F21S 8/04

(52) U.S. Cl. CPC F21V 23/02; F21S 8/04; F21V 23/001

(57) ABSTRACT

A power supply is from a source at ground level, via cables, to separate lighting fixtures proximate to ceiling at separation distance “d” which is typically in access of several feet.

### BACKGROUND OF THE INVENTION

This invention relates generally to lighting systems, and more particularly to light emitting diodes (LED) light systems in which the DC power supply is removed from the lighting fixture and is located elsewhere.

In prior LED light systems, the light fixtures contain a DC power supply. In such systems, it is known that if the LEDs or the DC power supply fails, the light fixture has to be replaced. It is also known that the LEDs have a much longer life than the DC power supply. Therefore, if the two components are separated, then the replacement of one component does not require the replacement of the entire light fixture unit.

### SUMMARY OF THE INVENTION

It is a major object of the invention to provide a system such that

a) one DC power supply is capable of driving multiple LED lighting systems are provided;

b) power supply to the fixture(s) is spaced therefrom, and can be replaced easily.

In such a system the fixture(s) are typically spaced well above the DC power supply, enabling simple change of the DC power supply to remedy failure of the system.

### DETAILED DESCRIPTION

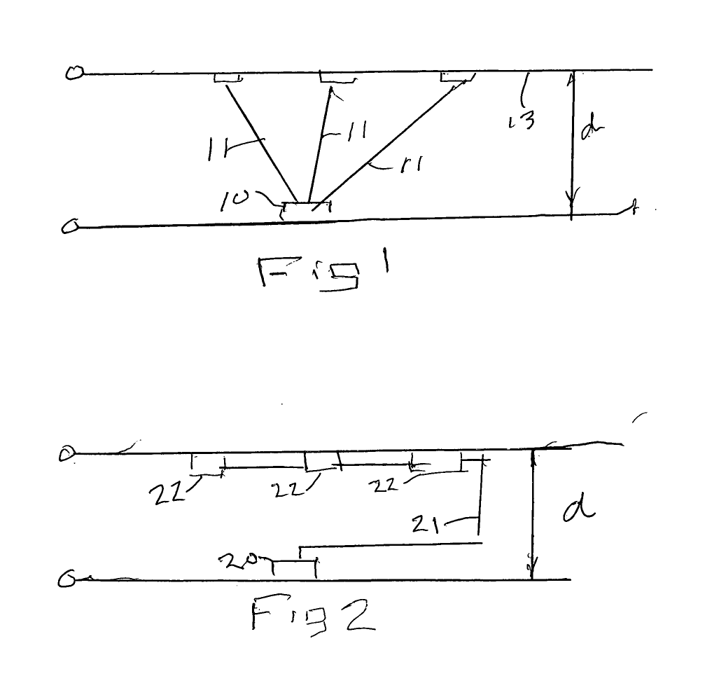

In FIG. 1, a DC power supply is from a source 10 at ground level via cables 11, to separate lighting fixtures proximate to ceiling 13, separation distance “d” is typically in excess of ten feet.

In FIG. 2, power is supplied from a source 20 via a single cable 21, to which lighting device(s) or fixture(s) 22 are provided proximate ceiling 23.

If DC power fails in either FIG. 1 or FIG. 2, power needing to be replaced, at accessible ground level, and simple manner, without changing the distance “d”.

I claim:

1. In a lighting system, the combination comprising
a) multiple lighting fixtures,
b) DC power supply to the fixtures spaced from the fixture(s) such that it can be replaced without interference from the

I claim:

1. In a lighting system, the combination comprising
a) multiple lighting fixtures,
b) DC power supply to the fixtures spaced from the fixture(s) such that it can be replaced without interference from the fixture(s).

2. The system of claim 1 wherein light fixtures are at a ceiling level and power supply is provided and spaced well below the fixture(s).

3. The system of claim 1 wherein DC power supply is at ground level and the light fixtures are proximate a ceiling.

4. The system of claim 1 wherein the light fixture(s) are at least ten feet from the DC power supply.
